(19) United States
(12) Patent Application Publication
(10) Pub. No.: US 2011/0055016 A1
(43) Pub. Date: Mar. 3, 2011

(54) METHOD AND APPARATUS TO DISTRIBUTE PROMOTIONAL CONTENT

(75) Inventor: SCOTT WHITE, Austin, TX (US)

(73) Assignee: AT&T INTELLECTUAL PROPERTY I, L.P., Reno, NV (US)

(21) Appl. No.: 12/552,890

(22) Filed: Sep. 2, 2009

(51) Int. Cl. G06Q 30/00

(52) U.S. Cl. 705/14.66

(57) ABSTRACT

A system that incorporates teachings of the present disclosure may include, for example, a computing device having a controller to receive descriptive information to customize an avatar presented by the computing device, transmit the descriptive information to a system, and receive from the system promotional content correlated to the descriptive information. Other embodiments are disclosed.

### FIELD OF THE DISCLOSURE

The present disclosure relates generally to promotional techniques and more specifically to a method and apparatus to distribute promotional content.

### BACKGROUND

Video games typically provide players optional avatars to choose from. Video games can also provide players the ability to define the look and feel of an avatar. For instance a player can choose clothing styles, color of hair, facial features, manner of speaking and so on. Similarly, virtual environment applications can provide users not only the ability to define avatars, but their surroundings. Avatar usage and customization has become a prevalent feature of many software applications.

Developments in speech synthesis and computer animation have also enabled the real-time synthesis of faces that look and sound like actual people. With recent advances in speech recognition, natural language interpretation and speech synthesis, conversational interfaces are finding wider acceptance. Collectively, these technologies can be used to produce human-like or animated interactive avatars.

### BRIEF DESCRIPTION OF THE DRAWINGS

FIGS. 1-2 depict illustrative embodiments of communication systems that provide media services;

FIG. 3 depicts an illustrative embodiment of a portal interacting with at least one among the communication systems of FIGS. 1-2;

FIG. 4 depicts an illustrative embodiment of a communication device utilized in the communication systems of FIGS. 1-2;

FIG. 5 depicts an illustrative embodiment of a method operating in portions of the communication systems of FIGS. 1-2;

FIG. 6 depicts an illustrative embodiment of a system operating according to the method of FIG. 7; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a computer-readable storage medium having computer instructions to receive from an avatar engine one or more customization settings of an avatar, detect a behavioral pattern from the one or more customization settings, identify promotional content that correlates to the detected behavioral pattern, and submit the promotional content to the avatar engine for presentation to a user of the avatar.

Another embodiment of the present disclosure can entail a method to receive descriptive information of an avatar, identify promotional content that correlates to a behavioral pattern detected from the descriptive information, and submit the promotional content.

Yet another embodiment of the present disclosure can entail a computing device having a controller to receive descriptive information to customize an avatar presented by the computing device, transmit the descriptive information to a system, and receive from the system promotional content correlated to the descriptive information.

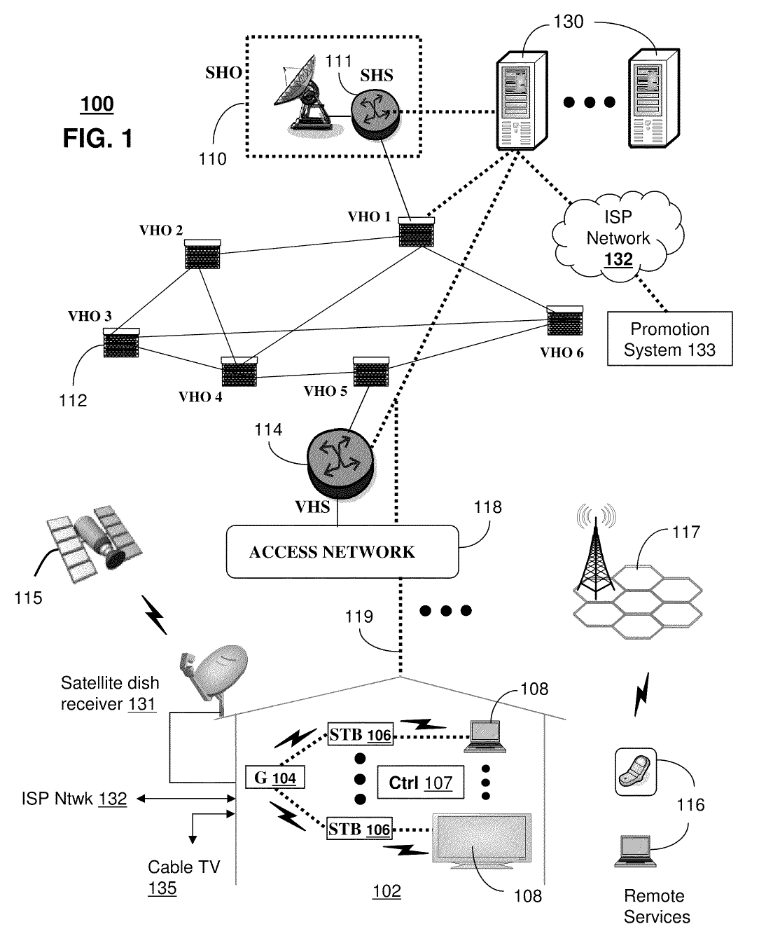

FIG. 1 depicts an illustrative embodiment of a first communication system 100 for delivering media content. The communication system 100 can represent an Internet Protocol Television (IPTV) broadcast media system. In a typical IPTV infrastructure, there is a super head-end office (SHO) with at least one super headend office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via an access network to commercial and/or residential buildings 102 housing a gateway 104 (such as a residential gateway or RG). The access network can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as Set-Top Boxes (STBs) which in turn present broadcast selections to media devices 108 such as computers or television sets managed in some instances by a media controller 107 (such as an infrared or RF remote control).

Unicast traffic can also be exchanged between the media processors 106 and subsystems of the IPTV media system to support interactive TV (iTV) services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In such embodiment, an integral device such as described can receive, respond, process and present multicast or unicast media content.

The IPTV media system can be coupled to one or more computing devices 130 a portion of which can operate as a web server for providing portal or web services over an Internet Service Provider (ISP) network 132 to fixed line media devices 108 or portable communication devices 116 by way of a wireless access point 117 providing Wireless Fidelity or WiFi services, or cellular communication services (such as GSM, CDMA, UMTS, WiMAX, etc.).

Another distinct portion of the one or more computing devices 130 can be used as an avatar engine (herein referred to as avatar engine 130) for generating and managing interactive avatars which users of communication system 100 can be presented for general assistance and presentation of interactive television (iTV) services as well as other common forms of media services. The avatar engine 130 can use common imaging technologies for creating avatars with human-like or animated qualities. The avatar engine 130 can also use common speech recognition and speech synthesis technologies to produce an interactive avatar. The avatar engine 130 can be used in any number of applications such as video games, virtual world environment applications, and instant messaging, just to mention a few.

The avatar engine 130 can be programmed to communicate with among other things a promotion system 133. The promotion system 133 can utilize common computing technology to process messages from the avatar engine 130 and identify promotional content as will be described below.

It will be appreciated by one of ordinary skill in the art that a satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132 for supporting iTV services. The communication system 100 can also be combined or replaced with analog or digital broadcast distributions systems such as cable TV systems 135.

It is further noted that the present disclosure can apply to any present or future interactive over-the-air or landline media content services.

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS compliant communication devices (CD) 201, 202, Public Switched Telephone Network (PSTN) CDs 203, 205, and combinations thereof by way of a Media Gateway Control Function (MGCF) 220 coupled to a PSTN network 260. The MGCF 220 is not used when a communication session involves IMS CD to IMS CD communications. Any communication session involving at least one PSTN CD requires the use of the MGCF 220.

IMS CDs 201, 202 can register with the IMS network 250 by contacting a Proxy Call Session Control Function (P-CSCF) which communicates with a corresponding Serving CSCF (S-CSCF) to register the CDs with at the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit queries to the ENUM system 230 to translate an E.164 telephone number in the SIP INVITE to a SIP Uniform Resource Identifier (URI) if the terminating communication device is IMS compliant.

The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214. The terminating S-CSCF 214 can then identify a terminating P-CSCF 216 associated with the terminating CD 202. The P-CSCF 216 then signals the CD 202 to establish communications.

If the terminating communication device is instead a PSTN CD such as references 203 or 205, the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD by common means over the PSTN network 260.

The aforementioned communication process is symmetrical. Accordingly, the terms “originating” and “terminating” in FIG. 2 are interchangeable. It is further noted that communication system 200 can be adapted to support video conferencing. In addition, communication system 200 can be adapted to provide the IMS CDs 201, 203 the multimedia and Internet services of communication system 100.

IMS network 250 can also be operably coupled to the avatar engine 130 previously discussed for FIG. 1. In this representative embodiment, the avatar engine 130 can be accessed over a PSTN or VoIP channel of communication system 200 by common techniques such as described above.

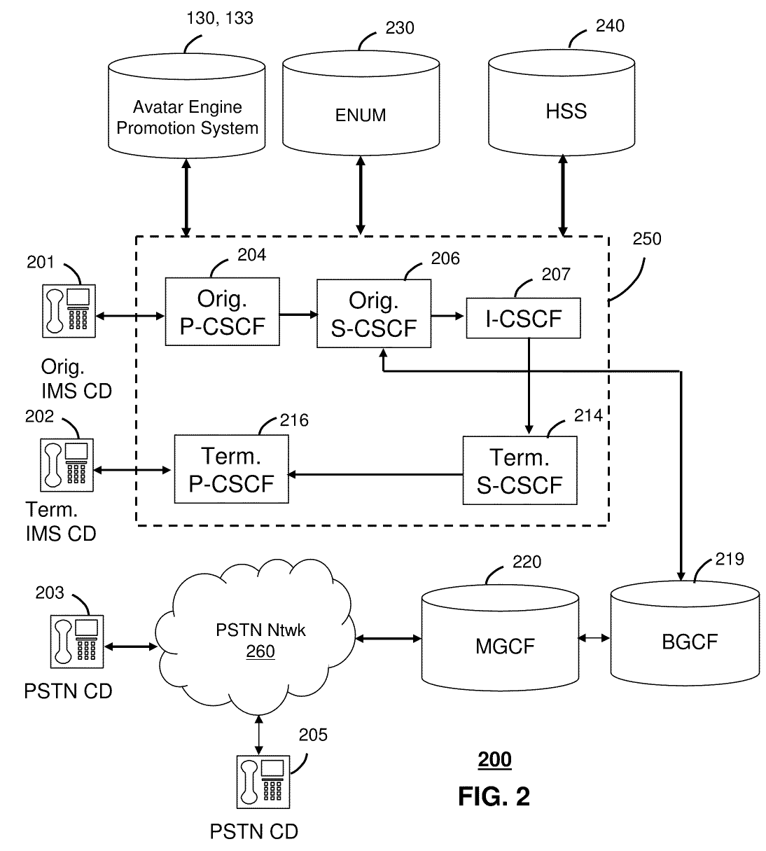

FIG. 3 depicts an illustrative embodiment of a portal 302 which can operate from the computing devices 130 described earlier of communication 100 illustrated in FIG. 1. The portal 302 can be used for managing services of communication systems 100-200. The portal 302 can be accessed by a Uniform Resource Locator (URL) with a common Internet browser such as Microsoft's Internet Explorer™ using an Internet-capable communication device such as those described for FIGS. 1-2. The portal 302 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

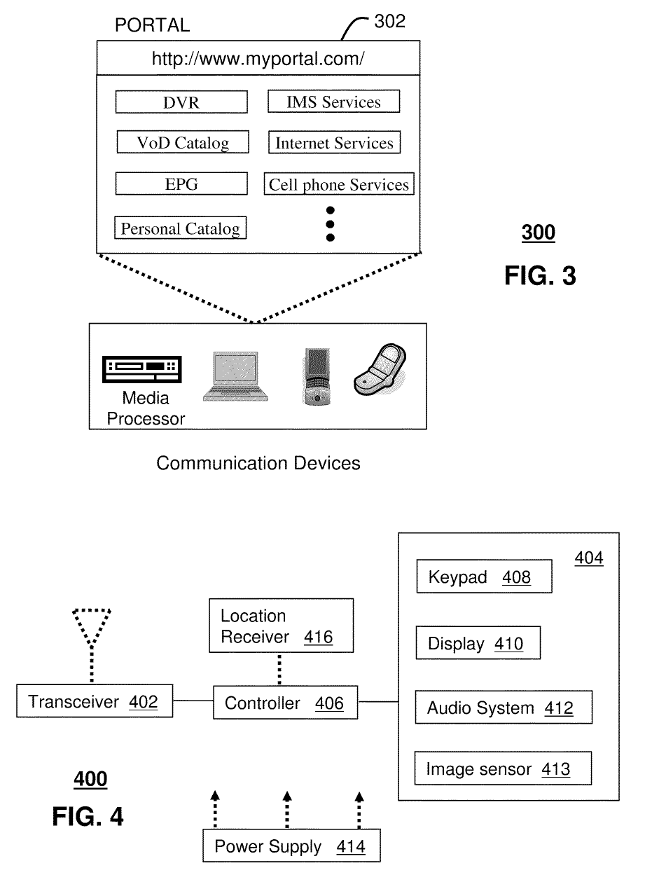

FIG. 4 depicts an exemplary embodiment of a communication device 400. Communication device 400 can serve in whole or in part as an illustrative embodiment of the communication devices of FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, joystick, mouse, or navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric dialing keypad commonly used by phones, and/or a Qwerty keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver for identifying a location of the communication device 400 based on signals generated by a constellation of GPS satellites, thereby facilitating common location services such as navigation.

The communication device 400 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such a Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

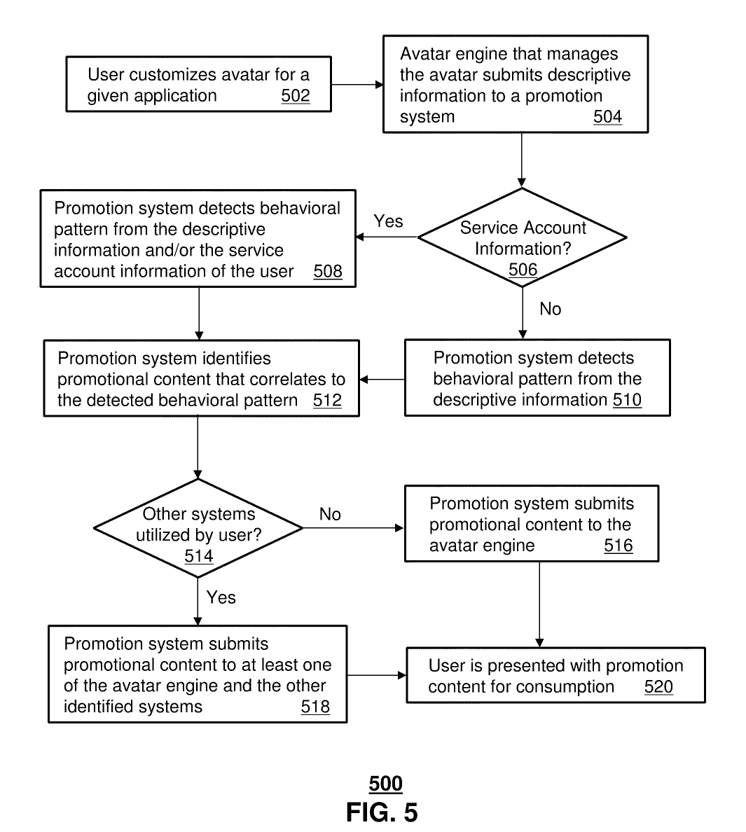

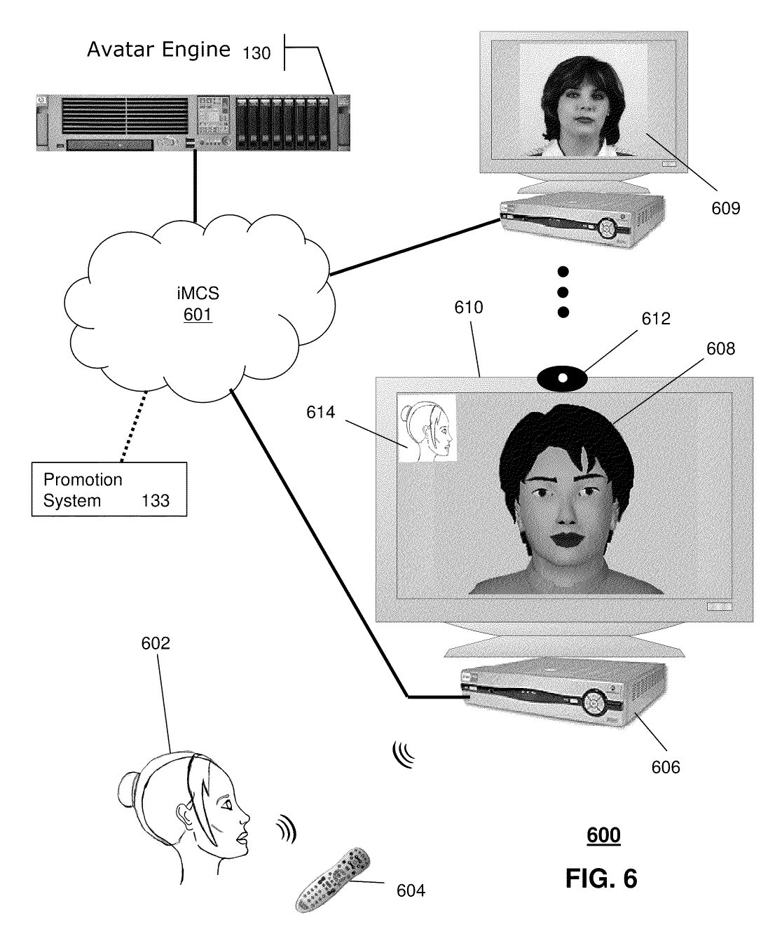

FIG. 5 depicts an illustrative method 500 operating in portions of communication systems 100-300. FIG. 6 depicts an illustrative embodiment of a system 600 operating according to the method of FIG. 5. FIG. 6 depicts an interactive media communication system 601 such as the systems shown in FIGS. 1-2 (singly or collectively). The interactive media communication system (iMCS) can be coupled to the avatar engine 130, the promotion system 133, and one or more STBs 606. The STBs 606 can be operatively coupled to media presentation devices such as a high-definition television (HDTV) 610 which can present avatar images 608 supplied by the avatar engine 130 by way of the STBs. A user 602 of the STB 606 can interact with the avatar image 608 by speech as well as tactile controls using a remote control 604.

The HDTV 612 can also have a common camera sensor 612 for capturing still and/or moving images of the user 602, which an be displayed in part by the HDTV as a picture-in-picture (PIP) image 614. The visual images of the user can be conveyed to the STB 606. Speech can be detected by a microphone of an audio system of the remote control 604 or an audio system of the STB 606. The avatar image 608 can be an animated image, or can have human-like qualities such as the avatar image 609. The STB 606 can transmit to the avatar engine 130 the visual images as well as speech signals of the user 602 for analysis.

The avatar engine 130 can be programmed to provide users general services, or an avatar for a gaming applications or virtual world environment applications. There can be other applications for an avatar which have not been described herein. The present disclosure contemplates the application of method 500, which follows below, to these undisclosed applications.

FIG. 5 depicts an illustrative method 500 that operates in portions of the communication system of FIG. 1. Method 500 can begin with step 502 in which a user is presented options to customize an avatar for a given software application operating in the avatar engine 130. The avatar engine 130 can be adapted to provide a video game service, a general communication services (e.g., instant messaging), a virtual world environment service (such as demonstrated by Second Life™), and so on. The avatar engine 130 may provide the user options to select the articles of clothing worn by the avatar (e.g., Cubs hat, baseball shirt, shorts, etc.). The user can also be given options to select the age, gender and appearance of the avatar (e.g., tall, short, medium height, long hair, colored eyes, Caucasian, etc.). The user may also be given options to define personality traits of the avatar (e.g., teenager, punk rock style, manner of speaking, mannerisms, etc.). In sum, the avatar engine 130 can be programmed with innumerable options to allow a user to define an avatar in a manner that may be desirable to the user.

Once the customization settings have been defined, the avatar engine 130 can in step 504 submit to the promotion system 133 descriptive information associated with the customization of the avatar. The promotion system 133 in step 506 can also determine whether service account information of the user has been supplied by a service provider of the avatar engine 130. The service account information can include useful information such as the age of the user of the avatar, gender of the user, other services the user is subscribed to (e.g., iTV, Internet, landline telephony, cellular telephony), the service packages chosen by the user (premium iTV channels, HDTV, high speed Internet service, nationwide landline calls, avatar services for video games, avatar services for instant messing, etc.), the total service fees paid by the user for all services, and so on.

From the service account information and the descriptive information of the avatar, the promotion system 133 can apply a common behavioral analysis algorithm to assess whether behavioral patterns of the user are apparent. For example, from the service account information, a behavioral analysis algorithm can identify a demographic profile of the user based on age, gender, level of fees paid for services, and type of services the user has subscribed to. The behavioral algorithm might also detect from the service account information psychographic behavioral patterns of the user such as traits, lifestyle, attitudes, and so on. Behavioral patterns can also be detected from analyzing the descriptive information of the avatar. For instance, the avatar may be dressed with a Cubs hat and shirt, which can indicate to the promotion system 133 that the user is a Cubs fan and likes baseball. The age of the avatar may indicate to the promotion system 133 that the user is young or may have a bias for youth if the service account information indicates the user is older than the defined avatar. The descriptive information of the avatar may also indicate that the user likes punk rock, and thereby may have an interest in punk rock bands, concerts, and paraphernalia, and so on.

If the promotion system 133 determines that service account information is available in step 506, it can proceed to step 508 where it can analyze the service account information and/or the descriptive information of the avatar and thereby detect the presence of behavioral patterns. If only descriptive avatar information is available, then the promotion system 133 can proceed to step 510. The detected behavioral patterns from either step can in turn be used to demographically and/or psychographically profile the user and/or identify general biases. Once such patterns are detected, the promotion system 133 can identify in step 512 promotional content that correlates to the detected behavioral patterns. Correlation can be strong or subtle. For example if the user selects a Cubs hat for the avatar it may be highly probable that s/he would be interested in promotional content associated with the Cubs baseball team. If, however, the detected pattern indicates generally that the user is interested in punk rock, but no punk rock band(s) have been detected, promotional content associated with punk rock bands and paraphernalia may have subtle correlation to the user's bias for punk rock. Promotional content can be represented by advertisements and/or promotions of goods or services that correlates to the behavioral pattern(s) detected.

In step 514, the promotion system can determine from the service account information, for example, whether the user is subscribed to services other than those provided by the avatar engine 130. If so, the promotion system 133 can submit in step 518 the promotional content to the avatar engine 130, and/or the other identified systems (e.g., iTV, instant messaging services, VoIP phone with message services, SMS to cellular phone, etc.). If there are no other systems are detected, then the promotion system 133 can submit the promotion content to the user by way of the avatar engine 130. The promotion content can then be presented to the user in step 520 by way of one or more systems for consumption. For example, the promotional content may include a portal link where the user can purchase paraphernalia for the Cubs. The present disclosure contemplates any suitable means for presenting promotional content which can inevitably redirect the user to consume goods or services of any kind.

Upon reviewing the aforementioned embodiments, it would be evident to an artisan with ordinary skill in the art that said embodiments can be modified, reduced, or enhanced without departing from the scope and spirit of the claims described below. For example, any functional aspects of the avatar engine 130 can be integrated or distributed to other systems. For instance, the avatar engine 130 can be an integral part of a gaming console, a computer, a personal digital assistant, or a remote server providing on-line avatar applications.

Other suitable modifications can be applied to the present disclosure without departing from the scope of the claims below. Accordingly, the reader is directed to the claims section for a fuller understanding of the breadth and scope of the present disclosure.

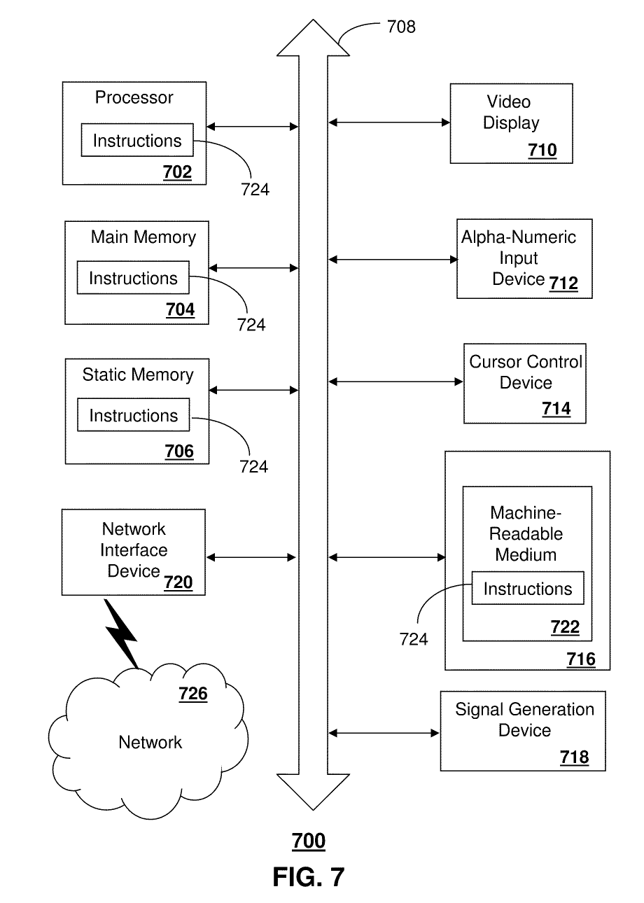

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions to:
receive from an avatar engine one or more customization settings of an avatar;
detect a behavioral pattern from the one or more customization settings;
identify promotional content that correlates to the detected behavioral pattern; and
submit the promotional content to the avatar engine for presentation to a user of the avatar.

2. The storage medium of claim 1, wherein the avatar engine provides at least one of communication services, virtual world environment services, and gaming services.

3. The storage medium of claim 1, wherein the promotional content corresponds to at least one of an advertisement and a promotion of goods or services.

4. The storage medium of claim 1, wherein the behavioral pattern corresponds to at least one of a demographic pattern and a psychographic pattern.

5. The storage medium of claim 1, wherein the one or more customization settings comprise at least one of one or more articles of clothing applied to the avatar, an appearance of the avatar, a personality applied to the avatar, a manner of speaking applied to the avatar, and a spoken language applied to the avatar.

6. The storage medium of claim 1, comprising computer instructions to:
receive service account information of a user of the avatar engine from a system of a service provider of the avatar engine; and
detect the behavioral pattern from at least one of the service account information of the user and the one or more customization settings.

7. The storage medium of claim 6, wherein the service provider of the avatar engine supplies the user of the avatar engine at least one of an interactive television (iTV) service, a internet service provider (ISP) service, and a telephony service.

8. The storage medium of claim 7, wherein the iTV service corresponds to one of an Internet Protocol Television (IPTV) service, an interactive cable TV service, and an interactive satellite TV service, and wherein the telephony service corresponds to one of a Public Switched Telephone Network (PSTN) service, a Voice over Internet Protocol (VoIP) service, and an IP Multimedia Subsystem (IMS) service.

9. The storage medium of claim 7, comprising computer instructions to submit the promotional content to at least one of the iTV service, the ISP service, and the telephone service of the user.

10. A method, comprising steps to:
receive descriptive information of an avatar;
identify promotional content that correlates to a behavioral pattern detected from the descriptive information; and
submit the promotional content.

11. The method of claim 10, comprising a step to submit the promotional content to a system utilized by a user of the avatar.

12. The method of claim 11, wherein the system utilized by the user comprises at least one of an avatar engine from which the avatar operates, an interactive television (iTV) system, a internet service provider (ISP) system, and a telephony system.

13. The method of claim 12, wherein the iTV system corresponds to one of an Internet Protocol Television (IPTV) system, an interactive cable TV system, and an interactive satellite TV system, and wherein the telephony system corresponds to one of a Public Switched Telephone Network (PSTN) system, a Voice over Internet Protocol (VoIP) system, and an IP Multimedia Subsystem (IMS) system.

14. The method of claim 12, wherein the avatar engine provides the user at least one of communication services, virtual world environment services, and gaming services.

15. The method of claim 10, wherein the promotional content corresponds to at least one of an advertisement and a promotion of goods or services.

16. The method of claim 10, wherein the behavioral pattern corresponds to at least one of a demographic pattern and a psychographic pattern.

17. The method of claim 10, wherein the descriptive information comprises at least one of one or more articles of clothing applied to the avatar, an appearance of the avatar, a personality applied to the avatar, a manner of speaking applied to the avatar, a description of environmental surroundings of the avatar, and a spoken language applied to the avatar.

18. The method of claim 10, comprising steps to:
receive service account information of a user of the avatar; and
detect the behavioral pattern from at least one of the service account information and the descriptive information.

19. A computing device, comprising a controller to:
receive descriptive information to customize an avatar presented by the computing device;
transmit the descriptive information to a system; and
receive from the system promotional content correlated to the descriptive information.

20. The computing device of claim 19, wherein the system is operable to:
receive the descriptive information from the computing device;
detect a behavioral pattern from the descriptive information;
identify the promotional content from a correlation thereby to the detected behavioral pattern; and
submit the promotional content to the computing device.
